(19) United States
(12) Patent Application Publication
(10) Pub. No.: US 2003/0072441 A1
(43) Pub. Date: Apr. 17, 2003

(54) Vibration generating device and cellular phones using the same

(76) Inventors: Koichi Kobayashi, Tokyo (JP); Shigemichi Sakata, Tokyo (JP); Minoru Suzuki, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/019,695

(22) PCT Filed: Mar. 30, 2001
(86) PCT No.: PCT/JP01/02709

(30) Foreign Application Priority Data
Jun. 7, 2000 (JP) 2000-170502
Mar. 6, 2001 (JP) 2001-62000

(51) Int. Cl. H04M 1/00; H04M 9/00

(52) U.S. Cl. 379/431

(57) ABSTRACT

There is provided a vibration generator 1 which is small sized but provides a sufficient vibration force and which is advantageous in assembly and packaging. A vibration generation portion of the vibration generator has a U-shaped leaf spring 2, 22 one end of which is fixed to a circuit board 6, a permanent magnet 3, 23 and an electromagnetic coil 4, 24. The permanent magnet is disposed on the leaf spring in a spaced confronting relation with the electromagnetic coil. The U-shaped leaf spring 2, 22 increase an actual length of the vibration portion to thereby lower a resonance frequency of the vibration portion so that vibration at the resonant point can be obtained and consequently a large vibration can be obtained efficiently by a small power. A power supply terminal device 30 can be provided for resiliently pressing from upward the vibration generation portion so that the power supply terminal device 30 serves not only as power source but also as a means for pressing an adhered portion of an adhesive tape.

### TECHNICAL FIELD

The present invention relates to an vibration generator favorably adaptable to portable telephones, pagers, personal handyphone systems, electric game machines, etc. and also provides a portable telephone utilizing the vibration generator.

### BACKGROUND ART

Vibration generators have been used for notifying the users of receiving calling signals which are received by portable telephones, pagers, etc. As the vibration generators of the type described, there are some types of vibration generators in which a weight is eccentrically held on an output shaft of a small-sized motor so that a center of gravity of the weight is shifted or displaced along with a rotation of a rotor of the motor to thereby generate vibration, and in which a permanent magnet is fitted in a floating manner to a planar vibration member so that the permanent magnet is vibrated in a pendulum fashion by an attracting force of a driving coil, as shown in Japanese Pre-Examination Publication No. 4-3630.

In a recent trend of miniaturization of parts and elements for the devices, an increasing demand has been made to provide a vibration apparatus that meets the requirements of both miniaturization and vibration efficiency with sufficient vibration.

In general, the vibration generators of the types described above are mounted in the devices such that they are adhered to an interior of the casings for portable telephones and pagers, etc.

In the vibration generator of the type that employs a motor, an attempt for obtaining a high energy requires increases in an eccentric weight and operational capacity which, however, inevitably lead to increase in size and cost and therefore are directed to obstruction against miniaturization and cost reduction. Besides the above, the portable phones at present have been promoted to be reduced in both size and weight to an extremity. For example, in the structure shown by Japanese Pre-examination publication No. 4-3630, it is extremely difficult to obtain a sufficient vibration force as a required vibration generating device by merely attempting miniaturization.

In addition, with respect to adoption or packaging of the vibration generator to the device such as portable phones and the like, it is likely that the adhesion by means of the adhesive agent as described above is peeled off to failure, so that it is required to keep the adhered portion be pressed from an opposite side of the adhered portion to prevent the peel off.

In this case, an attempt would be made to encase the vibration generator and it is adhered to one surface of the case by an adhesive tape, while a resilient or elastic material is provided between an opposite case surface and inner wall of the casing of the portable phone so that the adhered portion is kept compressed by a spring force of the resilient material. However, the casing is merely used for the purpose of providing a compression force only and, therefore, it results in less utility value of the casing itself and less cost efficiency. Further, a working efficiency is reduced by packaging the resilient material between the cases.

Further, in the pendulum type vibration generator described above, it is general that a spring steel is employed as the vibration plate.

Although the spring steel is a favorable material for obtaining an efficient vibration force because it has a sufficient spring characteristic and smaller magnetic resistance, it is inferior in wetting property of solder. Therefore, when the vibrating plate is required to be fitted directly to the substrate for the purpose of miniaturization and cost reduction, a serious problem of reliability to the vibration as well as unfavorable working effect due to inefficient soldering effect must be cleared.

Thus, the conventional vibration generators have serious problems of reliability and cost for packaging and assembly of the vibration generator to portable phones, etc.

### DISCLOSURE OF INVENTION

As mentioned above, the present invention has been accomplished in view of the shortcomings inherent in the prior art vibration generator. It is, therefore, an object of the present invention to provide an efficient vibration generator that permits a sufficient vibration force, attaining reduction of size.

Another object of the present invention is to provide a new vibration generator which permits high rate of assembly and packaging effect, with a high reliability in a required vibration.

Another object of the present invention is to provide a reliable portable phone which employs the vibration generator described above.

According to a first aspect of the present invention, there is provided a vibration generator comprising:

a vibration generation portion having a spring member, a permanent magnet and an electromagnetic coil, said permanent magnet being disposed on the spring member in a confronting spaced relation with the permanent magnet,

a driving circuit for driving the vibration generator portion to obtain a vibration force,

a casing for housing the vibration generation portion and the driving circuit,

wherein the spring member is formed of a U-shaped leaf spring to provide a vibration (swing) portion so that an actual length of vibration portion is increased.

By the structure described above, the spring can be made into a U-shape configuration to increase an actual length of the vibration (swing) portion so that resonance frequency at the vibration portion can be lowered and selectivity of the resonance point can be increased, resulting in an efficient and increased vibration force.

In a modification of the structure described above, one end of the spring member is directly fixed to, by soldering or adhesive agent, to a printed circuit board of the driving circuit. The direct fixture of the spring member is provides a simple structure and permits an efficient arrangement of the circuit elements and parts, so that a further incentive to miniaturization requirement can be established, and a sufficient coupling strength between the leaf spring (spring member) and the printed Circuit board can be obtained efficiently.

In a further modification of the structure described, a weight may be provided at an end of the leaf spring (spring member) which permits an efficient conversion of the driving energy of the electromagnetic coil into a vibration energy.

In a still further modification, the casing has an opening at the portion where the end of the leaf spring is located so that the weight can partly move out of the opening of the casing. This will help the casing to be made smaller so that miniaturization can be fulfilled.

According to a second aspect of the present invention, there is provided a vibration generator having a vibration generating portion and a driving circuit for driving the vibration generating portion to obtain a vibration force, comprising:

a leaf spring having a U-shaped vibration portion,

a permanent magnet and an electromagnetic coil,

the permanent magnet being disposed on the leaf spring in a spaced confronting relation with the electromagnetic coil, and

a power supply terminal device for resiliently pressing from upward the vibration generation portion.

In a modification of the second aspect of the invention, a weight may be provided at the end of the vibration portion. This permits a simple structure of the device and easy assembly to thereby obtain a reliability in the required vibration.

Further, the leaf spring can be combined with a yoke plate made of iron type materials so that the leaf spring is structurally integral with the yoke plate. This will provide a composite spring member having a spring property of the leaf spring and a magnetic property (low magnetic resistance) of the yoke plate. In this structure the leaf spring and the yoke plate are adhered to each other and therefore no special element or member is required for integration of the combined structure.

In a further modification, a desired adhesion means such as an adhesive tape is used along with, and in combination with, the usage of a resilient pressing force of the power supply terminal device.

The power supply terminal device serves to supply an electric power to the vibration generator by contacting with a pad or a substrate terminals of the application device (that is the electronic apparatus such as a portable phone, pagers, etc.) to which the vibration generator of the present invention is mounted. In this structure, if an adhesive tape is used to mount the vibration generator to the electronic apparatus, a resilient pressing force of the power supply terminal (that is, a lead pin) is always applied and effected to the connecting portion and, therefore, unexpected peel off due to shock, vibration and so forth of the adhesive tape can be prevented so that a packaging reliability can be assured.

Further, in a further modification, the leaf spring and the power supply terminal are made of phosphor bronze. This permits a suitable, direct soldering of the connecting portions of the leaf spring and the power supply terminal to the circuit substrate since phosphor bronze has an excellent soldering property. Thus, easy fitting can be obtained and a sufficient connecting force relative to and against shock or vibration.

In a further modification, the permanent magnet can be press-fitted to the leaf spring. This will simplify the fixing manner and arrangement and also provide a reliable fitting of the elements.

In the structure described above, the permanent magnet can be press-fitted to the leaf spring and the press-fitting portion can be adhered by means of an adhesive agent, so that the permanent magnet can be installed more reliably.

Further, the weight described above can be anchored by holding it between the leaf spring and the yoke plate. This structure does not require any special element or member for fixing the weight and, since the weight is held in a vertical direction (from upward to downward, that is, a direction of vibration) by the leaf spring and the yoke plate, a reliable fitting can be attained.

In a further modification, the weight can be held between the leaf spring and the yoke plate such that the holding portion is provided with an adhesive agent. This will improve the reliability of fitting of the weight.

Further, the power supply terminal device can be fixed to the circuit board. In this structure, a power from the application device such as a portable phone can be supplied directly to the circuit board and, therefore, any complex wiring can be omitted. Further, since the terminals are made of phosphor bronze, fixture of the elements can be made easily by soldering.

Further, the power supply terminal device may have a structure such that it has a resistive terminal plate having fall-prevention ribs. In this structure, if the power supply terminal device is mounted on the circuit board, the ribs are contacted with a head of the mounted elements and, therefore, a stable fitting can be obtained.

Further, the present invention provides a new portable phone which provides the inventive vibration generator described above.

According to the present invention, the vibration generator can be miniaturized and made at a reduced cost with high reliability and, therefore, it is suitable for notifying the user vibration for a portable phone and the like.

### BRIEF DESCRIPTION OF THE DRAWINGS

FIG. 1 is a perspective view of a vibration generator according to an embodiment of the present invention.

FIGS. 2A and 2B show a structure of the vibration generator according to the present invention, in which FIG. 2A is a plan view and FIG. 2B is a partly fragmented side view.

FIG. 3 is a perspective view of a part of the vibration generator, showing a fixing posture of a leaf spring in the vibration generator.

FIGS. 4A and 4B show a vibration generator according to another embodiment of the invention, in which FIG. 4A is a plan view and FIG. 4B is a side view.

FIGS. 5A and 5B show the structure of the leaf spring employed in the vibration generator of FIGS. 4A and 4B, in which FIG. 5A is a plan view and FIG. 5B is a side view.

FIGS. 6A and 6B show the structure of a yoke plate adaptable to the vibration generator of the present invention, in which FIG. 6A is a plan view and FIG. 6B is a side view.

FIG. 7 is a perspective view of the vibration generator shown in FIG. 4, showing the vibration generator in use.

### BEST MODE FOR CARRYING OUT THE INVENTION

Preferred embodiments of the invention will be described with reference to the accompanying drawings.

First Embodiment:

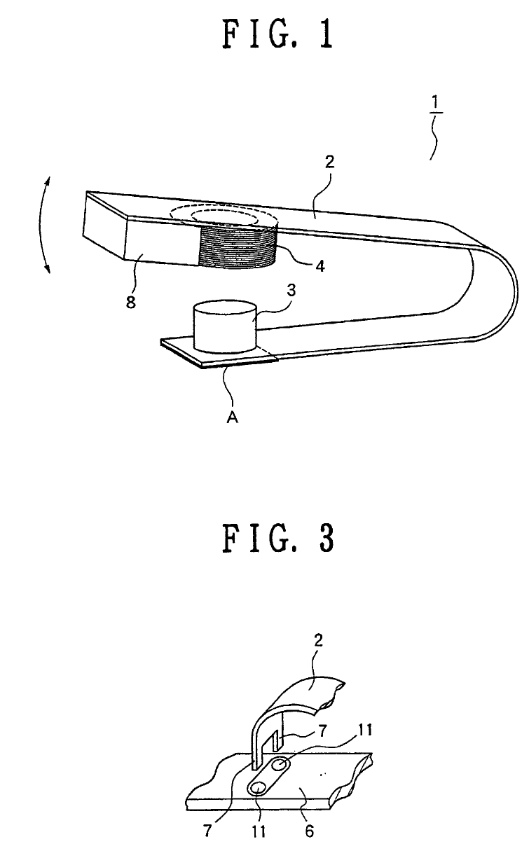

In FIGS. 1-3, a vibration generation portion 1 constituting a part of the vibration generator of the present invention employs a U-shaped leaf spring which is formed of a resilient longitudinal plate. A permanent magnet 3 is fitted to a lower end of the U-shaped leaf spring 2 and a magnetic coil 4 is provided to the other end of the U-shaped leaf spring 2 such that the magnetic coil 4 is provided in a resiliently floating relation and in a spaced confronting relation with respect to the permanent magnet 3. The permanent magnet 3 is fixed at its lower end “A” in FIG. 1 to a non-vibration body (not shown). In the structure described above, positions of the permanent magnet 3 and the magnetic coil 4 can be changed with each other such that the permanent magnet 3 in this case is provided in a resiliently floating relation relative to the magnetic coil 4 which in this case is provided in a fixed manner, which will be described presently in another embodiment of the invention. In the embodiment shown in FIG. 1, a weight (pendulum) is disposed at the end of the U-shaped leaf spring 2 adjacent to the magnetic coil 4.

As described above, in the present invention the spring member 2 which constitutes a vibration generation portion 1 is made into a U-shape configuration rather than a conventional planar shape. The U-shaped configuration permits an actual length of the vibration portion extending from the fixed portion A to the position of the weight 8 to be increased or extended as mush as possible in an extremely limited space of the device. Consequently, a resonance frequency of the vibration portion can be lowered and, at the same time, selectivity of the resonance point can be increased. Thus, an efficient vibration force can be obtained with the size being maintained small.

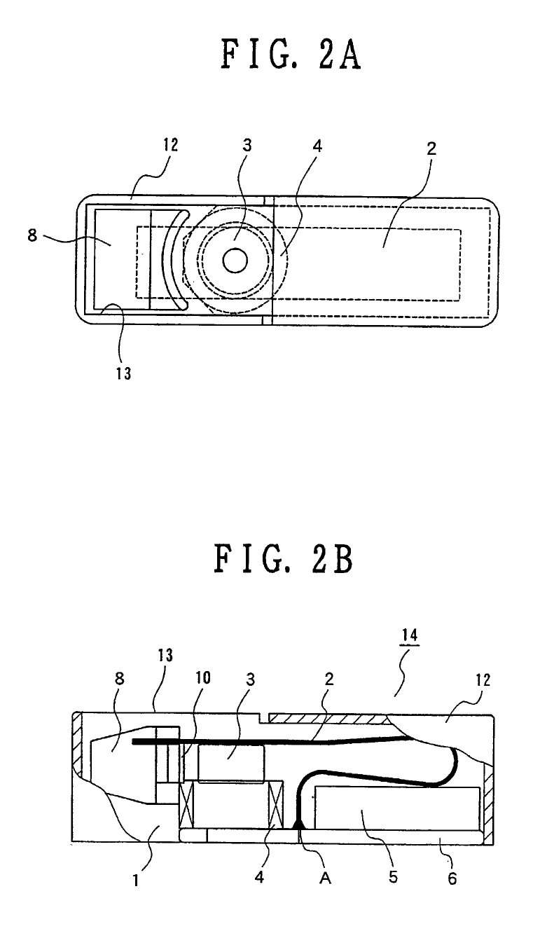

FIGS. 2A and 2B show a vibration generator 20 employing the vibration generation portion 1 shown in FIG. 1. The U-shaped leaf spring 2 has a structure that the weight 8 and the permanent magnet 3 are fixed to a movable portion in a resiliently floating manner. In the illustrated embodiment, which is different from the embodiment of FIG. 1, a magnetic coil 4 is provided below the permanent magnet 3 which is fixed to the leaf spring 2 in a resiliently floating manner. A yoke plate 10 is provided to a circumference of a part of the permanent magnet 3 so as to improve a magnetic effect of the permanent magnet 3 to thereby obtain a much larger vibration force. In case that not so large vibration force is required according to use or application, the yoke plate can be omitted.

The electromagnetic coil 4 is mounted on a left end portion of a printed circuit board 6 on which a driving circuit 5 for the electromagnetic coil 4 is mounted, and a fixed end portion of the U-shaped leaf spring 2 is fixed to a portion of reference character “A” adjacent to a center of the printed board 6. A lower space of the U-shaped leaf spring 2 is used for mounting various circuit elements which constitute an oscillation circuit, a current driving circuit, etc. (not shown) which are required for the driving circuit 5.

As shown in FIG. 3, the leaf spring 2 has two projections 7, 7 at its fixed portion so that the projections 7, 7 are inserted into through-holes 11,11 and fixed thereto by soldering. This will permit a simplified structure of the fittings and an easy positioning of the leaf spring 2. Further, a contact strength between the leaf spring 2 and the printed circuit board 6 can be assured.

The parts and elements constituting the vibration generation portion 1 and the driving circuit 5 are encased within a rectangular parallelepiped casing 12 to form a vibration generator 14 of this embodiment of the invention. The casing 12 has an opening 13 at an upper left portion of the drawing so that a part of the weight 8 can be projected out of the opening 13. Incidentally, the casing 12 has dimensions of 5 mm×5 mm×16 mm. However, in case that the vibration generator 14 of the invention is directly mounted on a mother board for a portable phone, the casing 12 is not always necessary or material to this invention. Further, the driving circuit 5 can be positioned at any other places than the position shown in FIGS. 2A and 2B.

In the structure of the vibration generator described above, when a command signal of vibration for portable phones, pagers, game machines and other small wireless machines are inputted to the vibration generator 14 of the invention, the driving circuit 5 excites the magnetic coil 4 by a square wave current or sinusoidal current which correspond to resonance frequency that is determined by an entire inertia weight of the vibration generation portion 1 (such as the weight 8, yoke plate 10, permanent magnet 3, etc.) and an elasticity or resiliency of the leaf spring 2, and attracting and retracting (repulsive) forces are repeatedly generated to thereby vibrate the permanent magnet 3 and the weight in a vertical (or, up-down) direction. Then, the weight 8 is resonated at the resonant point or adjacent thereto so that the induced current is converted efficiently to a large vibration energy. As described above, the U-shaped leaf spring 2 is used to lower favorably the resonance frequency of the vibration to a predetermined desired value and the selectivity of the resonance point is set at a higher point and, therefore, the structure of the invention, although its size is small, can provide a sufficiently large vibration force.

As described above, the U-shaped leaf spring is used for a spring member which constitutes the vibration generation portion and, therefore, a resonance frequency of the vibration portion (swing portion) is lowered so that vibration movement at the resonance point is available. Thus, a sufficiently large vibration force can be obtained by a relatively small supplied power. The vibration generator constituted mainly by the permanent magnet and the magnetic coil can be formed in a simple structure relative to the conventional, motor-driven vibration generator. Thus, the vibration generator of the invention can meet with the requirements for cost reduction as well as miniaturization.

Further, in a structure that the fixed end of the leaf spring is directly fixed to the printed circuit board by soldering or using an adhesive agent, fitting of the leaf spring can be processed easily and a further miniaturization can be realized. Further, since the connecting strength relative to the printed circuit board is obtained, the reliability can be increased.

Further, if the weight is fixed to the end of the leaf spring, a driving energy of the coil can be efficiently converted into a vibration energy and, therefore, a large vibration can be obtained effectively.

In addition, in the structure that the casing has an opening at the portion adjacent to the end of the leaf spring is located, the vibrating weight can project partly from the opening. Thus, the size of the casing can be made small to the utmost and this can meet with the recent strong requirements for miniaturization and light-weight for portable phones.

Second Embodiment:

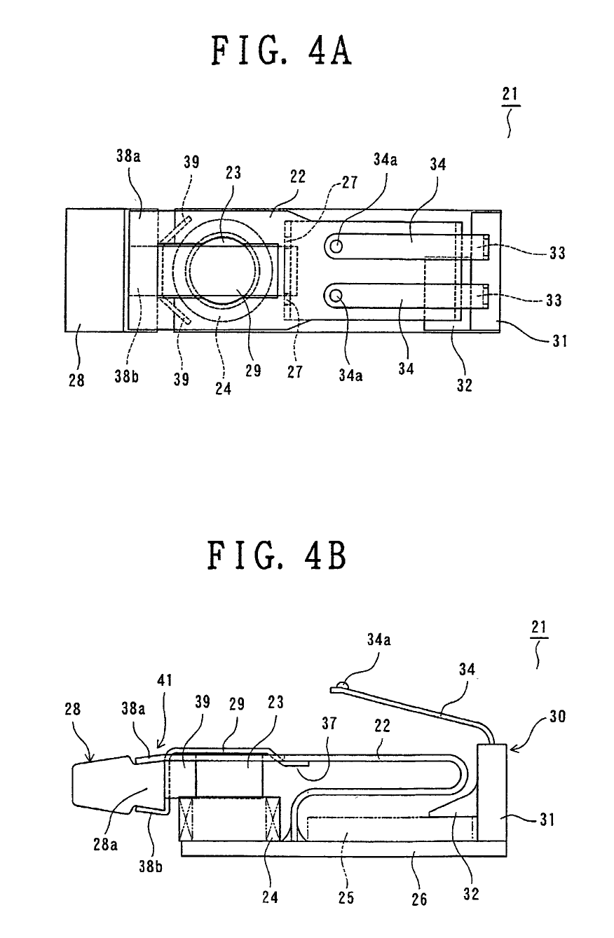

A second embodiment of the invention will be described with reference to FIGS. 4A-7.

In FIGS. 4A and 4B, a U-shaped leaf spring made of phosphor bronze has a weight 28 and a permanent magnet 23 at its vibration end portion in a resiliently floating manner, and an electromagnetic coil 24 at a confronting lower portion of the permanent magnet 23. A yoke plate 29 is fixed in a superimposed relation to the leaf spring 22. The yoke plate 29 constitutes a magnetic circuit of the permanent magnet 23 which, if made by an iron type material having less magnetic resistance, can improve a magnetic efficiency so that an efficient vibration can be obtained.

These elements such as a leaf spring 22, a yoke plate 29, a permanent magnet 23, an electromagnetic coil 24, a weight 28, etc. constitute a vibration generation portion of the vibration generator 21 of the invention.

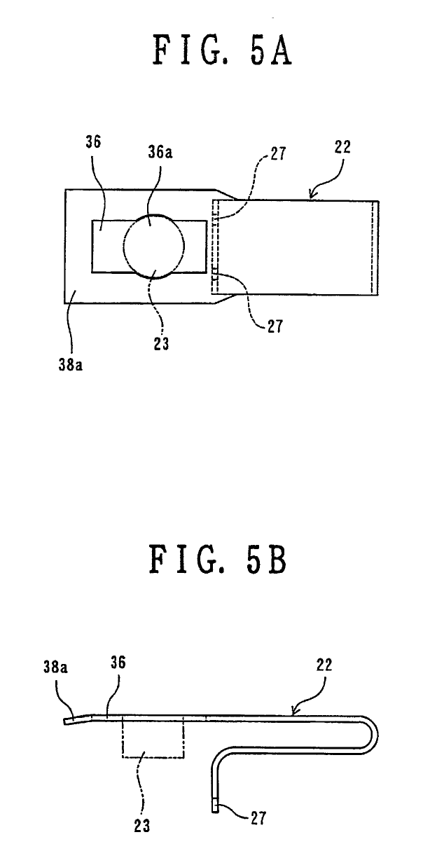

As shown in FIGS. 5A and 5B, the leaf spring 22 has a rectangular window 36 having a circular wide portion 36a at a central portion of an upper plate of the U-shaped leaf spring. In assembly, a top of the cylindrical or columnar permanent magnet 23 is press-fitted or forcibly inserted into the circular wide portion 36a. After insertion, it may be possible that an adhesive agent be applied to the press-fitted portion, if desired. This is shown in FIGS. 5A and 5B by two-dot phantom lines. As illustrated in FIG. 5B, an end (a left end in the drawing) of the leaf spring 22 is slightly bent downwardly to form a press-holding leaf 38a.

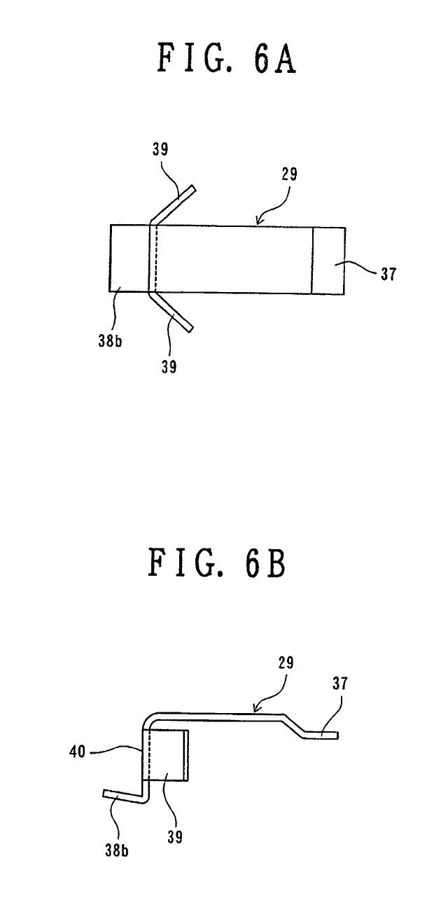

With respect to the yoke plate 29 in FIGS. 6A and 6B, a step portion 37 is formed on the right end of the plate member and its left portion is bent at right angles in the downward direction to form a downwardly bent portion 40 and then the extended end is raised to form a press-holding leaf 38b. Further, the downwardly bent portion 40 is provided with lugs 39, 39 at a predetermined angle.

In order to make the leaf spring 22 and the yoke plate in an integral or unitary structure, the permanent magnet 23 is press-fitted to the window 36 of the leaf spring 22, and each end portion of the yoke plate 29 (namely, the leftward, downwardly bent portion 40 and the rightward step portion) is fitted into a gap of the press-fitted portion so that a flat portion is superimposed on the leaf spring 22.

As described above, combination between the leaf spring 22 and the yoke plate 29 provides a composite spring device which has a spring characteristic of phosphor bronze and a high magnetic property of an iron type material, and this will produce a sufficiently large vibration by a simplified structure.

As illustrated in FIGS. 4A and 4B, a base portion 28a of the weight 28 is grasped or held vertically (that is, in the vibration direction) by a holding portion 41 which is constituted by the press-holding leaf 38a of the leaf spring 22 and the press-holding leaf 38b of the yoke plate 29.

When the weight 28 is held by the holding portion 41, the holding portion 41 is urged vertically outwardly so that the right end portion of the yoke plate 29 is shifted upward at a fulcrum of a top portion of the permanent magnet 23 which is exposed from the window 36 of the leaf spring 22, and the step portion 37 is strongly pressed against the inner side of the leaf spring 22. By the strong press force, both the leaf spring 22 and the yoke plate 29 are firmly held in a unitary structure. Further, if desired, an adhesive agent can be applied to the contacted portion to increase the engaging force between the holding portion 41 and the weight 28.

In this state, the lug 39 of the yoke plate 29 partly surrounds the permanent magnet 23 so that a magnetic efficiency of the permanent magnet 23 is improved to thereby obtain a larger vibration force.

Reference numeral 26 represents a circuit board that controls the drive of the electromagnetic coil 24. On the circuit board 26, not only the electromagnetic coil 24 and leaf spring 22 but also a number of circuit elements 25 (for example, IC elements) which constitute a driving circuit by the use of a space positioned below the U-shaped leaf spring 22 are installed. The electromagnetic coil 24 is fixed by an adhesive agent or the like, and the leaf spring 22 is fixed by soldering to the through holes 35, 35 of the circuit board 26. Since the leaf spring 22 in this embodiment is made of phosphor bronze, an effective and reliable soldering can be obtained so that a sufficient engagement strength relative to the circuit board 26 can be assured.

On the right-hand portion of the circuit board 26 in the figure of the drawing, a power supply terminal device 30 having at its proximal portion a terminal base 31 of a synthetic resin is disposed. The power supply terminal device 30 serves to receive an electric power for the circuit board 26 through two lead pins 34, 34 which are composed of phosphor bronze and extended obliquely from a top of the terminal base 31, and the power supply terminal device 30 is fixed to the circuit board by soldering the connecting terminals 33, 33 which are extended from a bottom of the terminal base 31. Incidentally, in a similar manner as the leaf spring 2 in the previous embodiment, soldering is applied to through-holes (not shown) in a favorable manner because phosphor bronze is used. Thus, a sufficient engagement strength can be obtained.

A rib 32 of a triangle pole shape is unitarily projected toward an interior of the circuit board at a middle portion of the terminal base 31. When the power supply terminal device 30 is mounted on the circuit board 26, a bottom of the rib 32 is contacted with a head of the circuit elements 25 to make the fitting stable to thereby prevent falling due to shock or vibration. In the present invention, the power supply terminal device 30 is utilized as a fixing means for enhancing a packaging operation for portable phones.

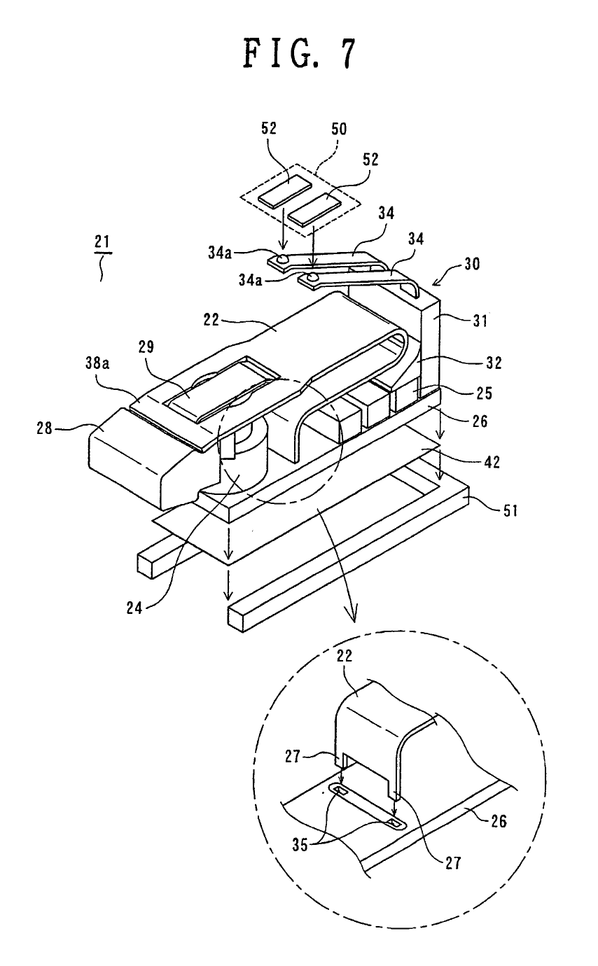

FIG. 7 shows a method for packaging the vibration generator 21 to the portable phones. As illustrated, a case-half of a casing of a portable phone (not shown) has a positioning frame 51 in its inner side so that the vibration generator 21 is packaged in the positioning frame 51. On the other hand, the other case-half has a substrate 50 (that is, a mother board) on which power supply pads 52, 52 are provided in a confronting relation with the lead pins 34, 34.

In the structure described above, the casing of the portable phone is opened and a back of the vibration generator 21 (that is, a rear surface of the circuit board 26) is adhered to the positioning frame 51 of the case by means of a double-coated tape and then a casing adapted to cover portable phone so that the power supply pads 52, 52 are contacted with the contacts 34a, 34a of the tip of the lead pins. By the contact force, the lead pin 34 is warped to press, at two points, an upper surface of the leaf spring 22 which is located below the lead pin 34. The pressing force of the lead pin 34 against the leaf spring 22 is acted on an engagement (adhesion) portion at the opposite side and, therefore, this prevents the double-coated tape 42 from peeling off due to humidity and vibration or shock, etc.

The contact points 34a, 34a of the lead pins 34, 34 are contacted with the power supply pads 52, 52 at the predetermined pressure and they are not separated from each other at the time of regular vibration operation and, therefore, a normal power supply can be obtained.

As described above, in the second embodiment of the invention, fixture and package is established by both the adhesive means using a double-coated tape 42 and a pressing force by the power supply terminal device 30 which serves also to supply an electric power and, therefore, a highly reliability of packaging to the portable phones can be obtained.

According to the second embodiment of the invention, the structure is simplified to the utmost by applying unification or integral formation of the leaf spring and the yoke plate and applying the fitting of the weight and the permanent magnet and, therefore, simplified assembly can be attained as well as miniaturization and cost reduction requirements. Further, since the leaf spring and the power supply terminal device are made of phosphor bronze, fixture by utilizing a solder can be attained so that assembly can be made easily. Further, a high reliability to anti-vibration can be obtained.

In addition to the above, fixture/packaging is established by using both the adhesive means of a double-coated tape 42 and a pressing force of the power supply terminal device 30 serving also to supply an electric power. Thus, a high reliability of packaging to the portable phones can be obtained. Besides, no resilient member or element for obtaining a pressure is required at all in the present invention and this attributes to cost reduction.

Accordingly, application of the vibration generator of the present invention to portable phones will contribute largely to miniaturization, cost reduction and high reliability of the resultant portable phones.

What is claimed is:

1. A vibration generator comprising:
a vibration generation portion 1 having a spring member 2, a permanent magnet 3 and an electromagnetic coil 4, said permanent magnet being disposed on the spring member in a confronting spaced relation with the permanent magnet,
a driving circuit 5 for driving the vibration generator portion 1 to obtain a vibration force,
a casing 12 for housing the vibration generation portion and the driving circuit 5,
wherein the spring member 2 is formed of a U-shaped leaf spring to provide a vibration portion so that an actual length of vibration portion is increased.

2. A vibration generator according to claim 1, wherein one end of the spring member 2 is directly fixed to, by soldering or adhesive agent, to a printed circuit board 6 of the driving circuit.

3. A vibration generator according to claim 1, wherein a weight 8 is provided at an end of the leaf spring 2 for permitting an efficient conversion of the driving energy of the electromagnetic coil into a vibration energy.

4. A vibration generator according to claim 1, wherein the casing 12 has an opening 13 at the portion where the end of the leaf spring 2 is located so that the weight can partly move out of the opening of the casing.

5. A vibration generator having a vibration generating portion 21 and a driving circuit 25 for driving the vibration generating portion to obtain a vibration force, comprising:
a leaf spring 22 having a U-shaped vibration portion,
a permanent magnet 23 and an electromagnetic coil 24,
the permanent magnet 23 being disposed on the leaf spring 22 in a spaced confronting relation with the electromagnetic coil 24, and
a power supply terminal device 30 for resiliently pressing from upward the vibration generation portion 21.

6. A vibration generator according to claim 5, wherein a weight is fixed to the end of the vibration portion.

7. A vibration generator according to claim 5, wherein the leaf spring is combined with a yoke plate made of iron type materials so that the leaf spring is structurally integral with the yoke plate.

8. A vibration generator according to claim 5, wherein an adhesion means using an adhesive tape is used along with, and in combination with, a resilient pressing force of the power supply terminal device.

9. A vibration generator according to claim 5, wherein the leaf spring and the power supply terminal are made of phosphor bronze.

10. A vibration generator according to claim 5, wherein the permanent magnet is press-fitted to the leaf spring to thereby simplify the fixing manner and arrangement and also provide a reliable fitting of the elements.

11. A vibration generator according to claim 5, wherein the permanent magnet 23 is press-fitted to the leaf spring 22 and the press-fitting portion can be adhered by means of an adhesive agent.

12. A vibration generator according to claim 6, wherein the weight 28 is anchored by holding it between the leaf spring 22 and the yoke plate 29.

13. A vibration generator according to claim 6, wherein the weight 28 is held between the leaf spring 22 and the yoke plate 29 such that the holding portion is provided with an adhesive agent.

14. A vibration generator according to claim 5, wherein the power supply terminal device 30 is fixed to the circuit board by soldering.

15. A vibration generator according to claim 5, wherein the power supply terminal device 30 has a resistive terminal plate 31 having falling-prevention ribs 32.

16. A vibration generator according to claim 1 or 5, whherein the vibration generator is used for portable phones.
